(19) United States
(12) Patent Application Publication
(10) Pub. No.: US 2026/0049820 A1
(43) Pub. Date: Feb. 19, 2026

(54) SYSTEM

(71) Applicant: SOFTBANK GROUP CORP., Tokyo (JP)

(72) Inventor: Ryota NOMURA, Tokyo (JP)

(73) Assignee: SOFTBANK GROUP CORP., Tokyo (JP)

(21) Appl. No.: 19/299,424

(22) Filed: Aug. 14, 2025

(30) Foreign Application Priority Data
Aug. 16, 2024 (JP) 2024-137134

(51) Int. Cl. G01C 21/20; G02B 27/01; G06V 10/94; G06V 20/40

(52) U.S. Cl. CPC G01C 21/20; G02B 27/0172; G06V 10/95; G06V 20/41

(57) ABSTRACT

A system includes a processor that is configured to capture front-facing video data, analyze the captured video data using an analysis server, output information based on the analyzed video data as audio guidance to a visually impaired user, and display information based on the analyzed video data as augmented reality on a display.

### CROSS-REFERENCE TO RELATED APPLICATION

This application is based on and claims priority under 35 USC 119 from Japanese Patent Application No. 2024-137134 filed on Aug. 16, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

There is a need for a system that enables visually impaired individuals to safely and efficiently obtain real-time information about their surroundings, including dynamic obstacles and environmental cues, in order to support independent mobility. Conventional assistive devices often lack the capability to provide comprehensive and context-aware guidance combining both audio and visual (augmented reality) feedback, which results in limited situational awareness for the user.

### SUMMARY

To address these problems, the invention provides a system comprising a processor configured to capture front-facing video data, analyze the captured video data using an analysis server, output information based on the analyzed video data as audio guidance to a visually impaired user, and display information based on the analyzed video data as augmented reality on a display. The system further enables wireless transmission of video data to the analysis server, employs multimodal artificial intelligence for video analysis, and generates and decodes data for both audio guidance and augmented reality display, thereby facilitating comprehensive and real-time situational awareness for visually impaired users.

“Processor” means a hardware or software component capable of executing instructions and performing computational tasks to control and manage system operations.

“Video data” means a sequence of digital images captured over time representing the visual information of a scene.

“Analysis server” means a computing device or system configured to receive, process, and analyze data, particularly video data, using various algorithms or artificial intelligence. “Audio guidance” means audible information or instructions provided to the user to assist in understanding or interacting with the surroundings.

“Augmented reality” means technology that overlays digital information, such as graphics or icons, onto the user's view of the real world to enhance perception.

“Wireless network” means a communication network that transmits data between devices without the need for physical wired connections.

“Multimodal artificial intelligence” means an artificial intelligence system that simultaneously processes and integrates information from multiple types of data, such as visual, auditory, and textual inputs.

“Decode” means the process of converting encoded or compressed data back into a format that can be perceived or used by system components.

“Display means” means a component or device capable of visually presenting information, including graphics, text, or icons, to the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

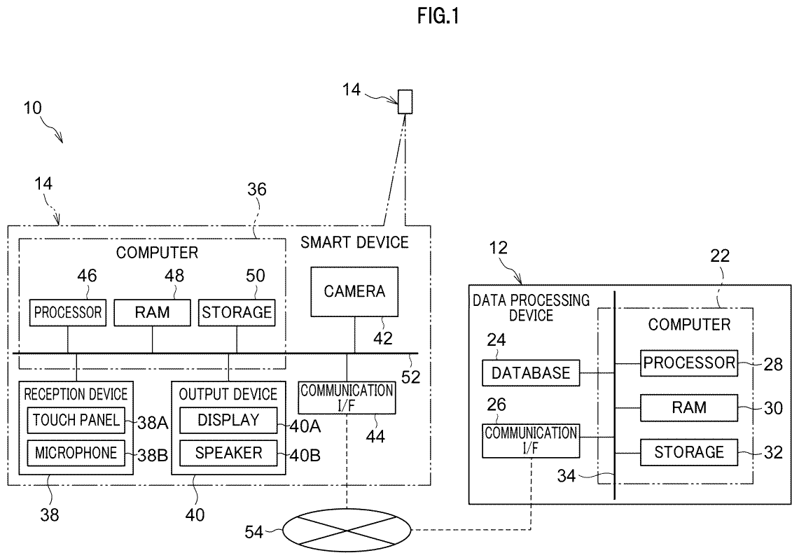

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

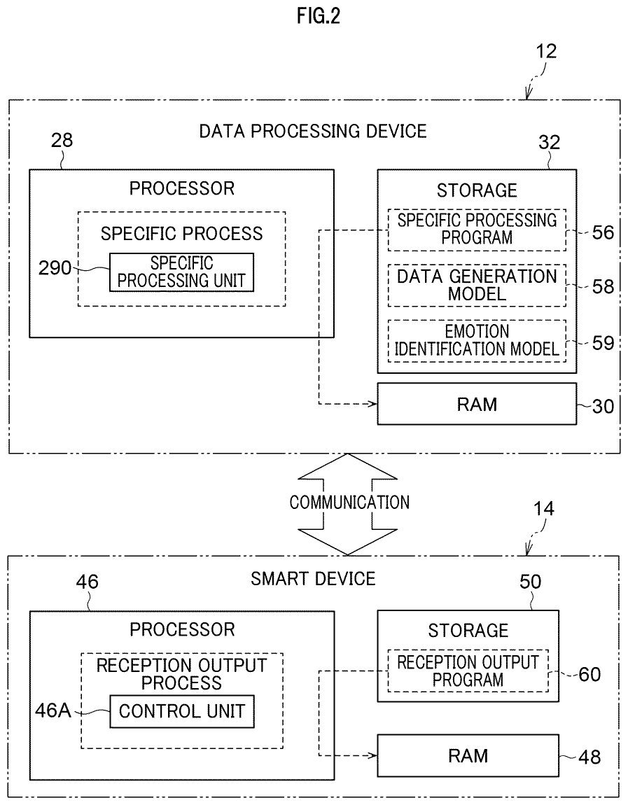

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Visually impaired individuals often face significant challenges in accurately perceiving and understanding their surrounding environment, which can hinder their ability to move safely and independently. Conventional visual support systems frequently lack real-time processing capabilities, fail to provide timely and relevant information, and do not adequately utilize advanced data analysis technologies to integrate multiple sources of contextual information. As a result, users may not receive sufficient guidance or situational awareness necessary for safe navigation and daily activities.

The specific processing by the specific processing unit 290 of the data processing device 12 in Example 1 is realized by the following means.

The present invention provides a server comprising a processor configured to acquire image information from the user's environment, perform compression and transmission of the image data, restore and analyze the image information using a generative information processing model to identify objects, humans, and characters, and generate audio guidance as well as augmented reality visual information for the user in real time. This enables the user to receive comprehensive, accurate, and timely guidance regarding their environment, thereby enhancing their ability to safely and independently navigate various settings.

The term “processor” refers to an electronic circuit or component capable of executing instructions, performing computations, and controlling operations within the system.

The term “acquisition unit” refers to a device or component that obtains image information from a physical environment, typically through optical sensors such as cameras.

The term “image information” refers to data representing visual characteristics of the surrounding environment, including but not limited to color, shape, position, and texture of objects captured by imaging devices.

The term “information compression method” refers to a computational technique used to reduce the size of data for efficient transmission or storage, while retaining essential information content.

The term “wireless communication line” refers to any medium or channel that enables data transmission between devices without physical cables, such as radio waves, infrared, or other wireless technologies.

The term “generative information processing model” refers to an artificial intelligence model capable of analyzing input data and producing output by recognizing patterns, synthesizing interpretations, and generating structured information, such as guidance messages or visual overlays.

The term “object recognition” refers to a process in which computational methods identify and classify objects present within image information.

The term “human recognition” refers to a process in which computational methods detect, identify, or track human figures or faces within image information.

The term “character recognition” refers to a process in which computational methods extract, identify, and interpret alphanumeric characters or text embedded within image information.

The term “audio guidance information” refers to synthesized or pre-recorded speech or sound data presented to the user to convey situational awareness, instructions, warnings, or navigational cues.

The term “augmented reality information” refers to visual data overlaid onto the user's view of the real environment, providing additional contextual cues or guidance beyond the naturally perceived scene.

The term “analysis unit” refers to a component or system responsible for processing received data, performing interpretation, and generating output information for further action.

### Embodiment for Implementing the Invention

The present invention may be embodied as a system comprising a terminal (such as smart glasses equipped with a camera, audio device, and display) and a server (comprising information processing hardware and a generative AI model). The terminal is worn by the user and visually captures the scene in front of the user through an imaging acquisition unit, which is typically realized by an image sensor or camera module. The captured image information is then compressed using an information compression method, such as the H.265 codec implemented via a standard multimedia processing library.

The terminal transmits the compressed image information via a wireless communication line, such as Wi-Fi or mobile data networks, to the server. The server includes a processor configured to restore the received image information and analyze the restored image using a generative information processing model. The server may employ advanced hardware such as a high-performance graphics processing unit, and typical software may include object detection models (for example, YOLOv5), semantic segmentation models (for example, DeepLabV3+), and text recognition models (for example, an optical character recognition engine such as Tesseract). The server identifies relevant objects, humans, or characters within the image, and generates audio guidance information and augmented reality information based on the analysis. The audio guidance information is constructed as synthesized speech or sound sequences using a speech synthesis engine, such as a text-to-speech module. The augmented reality information is formed as overlay data (icons, arrows, or text boxes) which provide visual cues when displayed by the terminal.

The terminal receives the audio and AR information, decodes them, and presents them to the user. Audio guidance is delivered via speakers or bone-conduction headphones to ensure that users with visual impairments receive timely and clear instructions. The AR information is rendered on the terminal's display as an overlay on the real-world view, assisting the user with visual cues about hazards, directions, or key locations.

For example, when a user is about to cross a road and a bicycle approaches, the terminal captures the scene and sends it to the server. The server, by employing its AI models, identifies the bicycle and estimates relevant movement parameters. The server then generates a warning message, such as “A bicycle is approaching from your left. It will cross in approximately three meters,” and also produces AR overlay data to show an arrow indicating the bicycle's path on the display. This information is returned to the user's terminal, ensuring the user is guided both audibly and visually for safe navigation.

Example prompt sentences for a generative AI model include:

“Please describe the process by which the server in a visual support system for the visually impaired receives video data, analyzes it to detect persons, objects, and text, and generates both audio guidance and augmented reality overlay data for the user.”

“Outline, in detail, the method by which smart glasses compress and transmit captured video to an analysis server, including specifics about the hardware, compression algorithms (such as H.265), and wireless communication protocols employed.”

This embodiment utilizes commonly available electronic hardware and software resources, and can be implemented on a variety of general-purpose or dedicated devices suitable for wearable terminal functions and high-performance data analysis servers.

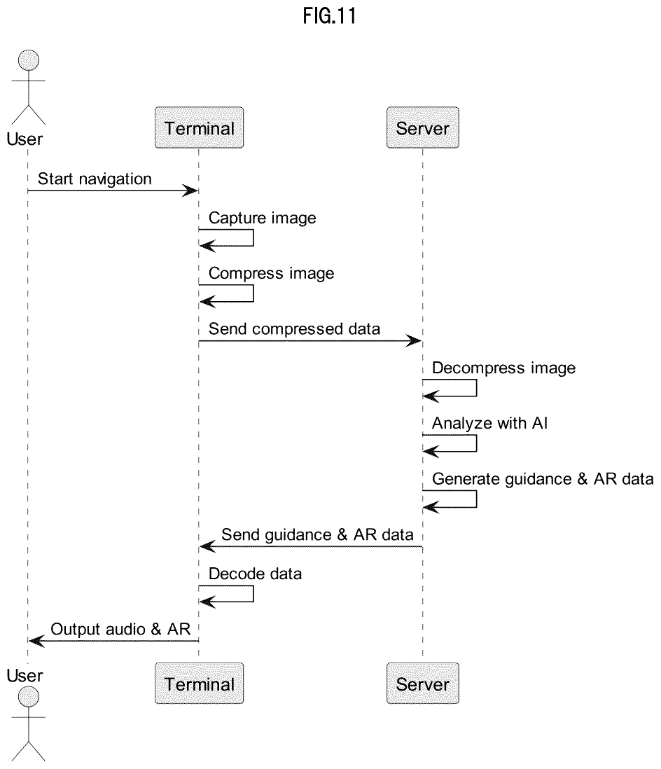

The following describes the processing flow using FIG. 11.

### Step 1:

The terminal captures image information from the user's environment using a built-in camera.

Input: The real-world scene in front of the user.

Data Processing: The terminal converts optical signals into digital image frames, typically at a rate of 30 frames per second, and formats them for further processing.

Output: Raw high-resolution video frames representing the current environment.

### Step 2:

The terminal performs compression of the captured image information using an information compression method, such as an H.265 encoder implemented via multimedia processing software.

Input: Raw video frames from the camera module.

Data Processing: The terminal encodes the image data frame-by-frame, reduces redundancy, and creates a compressed video stream that maintains essential visual information while lowering bandwidth usage.

Output: Compressed video data ready for wireless transmission.

### Step 3:

The terminal transmits the compressed video data to the server through a wireless communication line, such as Wi-Fi or a mobile data network.

Input: Compressed video data generated in the previous step.

Data Processing: The terminal packages the data for secure transmission, establishes a wireless network connection, and continuously sends video packets to the server.

Output: Successfully transmitted compressed video data received by the server.

### Step 4:

The server receives and restores the compressed video data, reconstructing the original image information.

Input: Compressed video data received through the wireless communication line.

Data Processing: The server decodes the data using an H.265 decoder, restoring the high-resolution image frames for analysis.

Output: Restored video frames suitable for AI analysis.

### Step 5:

The server analyzes the restored image information using a generative AI model, which includes object recognition, human recognition, and character recognition modules.

Input: Restored high-resolution video frames.

Data Processing: The server applies deep learning models to each frame, identifies and classifies targets (such as people, vehicles, bicycles, or text), predicts their trajectories, and aggregates the contextual understanding of the scene.

Output: Structured analytical data containing identified objects, recognized characters, positions, and movement predictions.

### Step 6:

The server generates audio guidance information and augmented reality visual information based on the analysis results.

Input: Structured analytical data from AI models.

Data Processing: The server synthesizes appropriate guidance messages using text-to-speech software and prepares augmented reality overlay data describing icons, arrows, or markers for visual presentation.

Output: Encoded audio message data and structured AR overlay data.

### Step 7:

The server compresses the audio and AR overlay data, and transmits them to the terminal via the wireless communication line.

Input: Guidance audio data and AR overlay data generated by the server.

Data Processing: The server compresses audio using an audio codec, optimizes AR data size, and securely transmits both types of data to the terminal in real time.

Output: Compressed audio guidance and AR overlay data received at the terminal.

### Step 8:

The terminal decodes and outputs the received audio guidance and AR overlay data for the user. Input: Compressed audio and AR data received from the server.

Data Processing: The terminal decodes the audio using speech synthesis playback and displays the AR overlays on the transparent display surface, aligning icons and messages with real-world objects.

Output: The user receives both timely audible guidance and visual augmented reality cues, enhancing situational awareness and safety during navigation.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

There is a need for a system that enables users, including those with visual impairments, to perceive and understand their surroundings and potential dangers in real time, even in complex and dynamic environments such as factories or urban streets. Conventional systems do not adequately provide personalized guidance that adapts to not only the user's surrounding situation but also the user's emotional state, especially under stressful or dangerous conditions. Therefore, it is an object of the present invention to provide a system that delivers adaptive auditory and visual guidance based on comprehensive real-time environmental and emotional analysis to significantly enhance user safety and situational awareness.

The specific processing by the specific processing unit 290 of the data processing device 12 in Application Example 1 is realized by the following means.

The present invention provides a server comprising a processor configured to acquire input information such as environmental data and biometric data from an input device, analyze the input information using a generative artificial intelligence model to recognize the user's surrounding situation and estimate the user's emotional state, generate context-aware auditory and augmented reality visual guidance based on the recognized situation and estimated emotional state, and transmit the generated guidance to the user via auditory and visual presentation devices. This enables real-time delivery of personalized, adaptive situational and emotional support, allowing users, including those with visual impairments, to safely and confidently navigate complex environments.

The term “processor” refers to an information processing unit that executes instructions and manages the operations of various system components.

The term “input device unit” refers to one or more devices for acquiring real-world information, such as environmental images, audio signals, or biometric data, from a user or the surrounding environment.

The term “communication device unit” refers to a hardware and/or software component configured to convert input information into a predetermined format and transmit it via a communication network.

The term “information processing device unit” refers to a computational entity that receives, stores, and conducts analysis on input information transmitted from an input device unit. The term “data generation unit” refers to a functional block or module configured to generate data based on the analysis results provided by the information processing device unit. The term “auditory presentation device unit” refers to hardware and/or software configured to convert auditory information into audio signals and deliver them to a user, such as through a speaker or earphone.

The term “visual presentation device unit” refers to hardware and/or software configured to present visual information as augmented reality, often by overlaying generated content on a display viewable by the user.

The term “biometric information” refers to physiological or behavioral data obtained from the user, including but not limited to heart rate, voice features, facial expression, or body temperature.

The term “acoustic information” refers to sound signals collected from the user or environment, typically through a microphone, including spoken voice and environmental noise.

The term “emotion estimation unit” refers to a module or algorithm configured to analyze biometric and acoustic information in order to estimate the user's emotional state.

The term “control unit” refers to a system component that modifies or adjusts the contents or expressions of output information based on the emotional state or other analysis results.

The term “generative artificial intelligence model” refers to a machine learning system capable of analyzing complex patterns in input information and generating appropriate responses or output data, including, but not limited to, deep learning-based pattern recognition or context understanding modules.

The term “wireless communication” refers to any method of transmitting information without physical connection, including but not limited to radio, optical, or electromagnetic transmission technologies.

The term “augmented reality” refers to technology that integrates and displays generated visual information with a real-world view in order to assist or guide the user.

An embodiment of the invention is described in detail below, based on the scope of the claims.

The system comprises a processor, an input device unit, a communication device unit, an information processing device unit, a data generation unit, an auditory presentation device unit, a visual presentation device unit, an emotion estimation unit, and a control unit.

The terminal acquires environmental information from the user's surroundings via an input device unit, such as a camera, microphone, and biometric sensors. The camera may be, for example, a CMOS-based module capable of capturing real-time video at a frame rate of 30 frames per second. The microphone acquires ambient sound and the user's voice, and the biometric sensors acquire data such as heart rate and body temperature.

The terminal uses a signal processing software module such as FFmpeg to compress and preprocess the acquired video and audio data. The processed data, along with biometric information, are transmitted in real-time from the terminal to the server via a wireless communication module, such as a Wi-Fi transceiver operating under control software such as wpa_supplicant.

The server receives the transmitted data using the information processing device unit and decodes the video and audio input using libraries such as OpenCV and FFmpeg. The server applies a generative artificial intelligence model, such as a deep learning-based multimodal object detection algorithm (for example, YOLOv5 implemented in PyTorch), to analyze the video frames and identify potentially hazardous objects and their trajectories, such as approaching vehicles or machinery in a factory environment. In parallel, the server analyzes the user's emotion by applying audio analysis and biometric estimation using models implemented in TensorFlow or similar frameworks.

The data generation unit then generates personalized guidance, synthesizing auditory output through a text-to-speech module (such as those provided by a commercial cloud service or open-source TTS library) and creating visual information for augmented reality presentation. The content and style of this auditory and visual output are controlled and adapted by the control unit according to the estimated emotional state of the user, as determined by the emotion estimation unit.

The auditory presentation device unit outputs the generated guidance as speech using a speaker or bone-conduction audio system. The visual presentation device unit overlays augmentation, such as icons, arrows, or alerts, onto the user's display (such as an optical see-through display or an OLED micro-display).

In one specific example, the user wears smart glasses equipped with the aforementioned modules while moving through a factory floor. When the system detects a forklift approaching from the right, and further determines that the user is in an anxious state, the server generates the auditory message “Stay calm. Caution, a forklift is approaching from your right,” and displays a red arrow on the right side of the display. The user receives these auditory and visual cues, enabling safe and confident navigation within the environment.

Another example is a visually impaired user walking in an urban environment. The terminal captures the surroundings and the user's emotional signal, sends them to the server, and the system generates timely announcements and AR guidance, such as “Be careful, a bicycle is approaching from ahead,” adjusting the guidance according to an anxious or calm state detected in the user.

This embodiment uses commercially available components, such as CMOS camera modules, Wi-Fi chipsets, open-source or commercial AI frameworks (PyTorch, TensorFlow, OpenCV, FFmpeg), TTS modules, and AR-capable display devices. The server may be implemented on a general-purpose computing platform or in a distributed cloud environment.

A sample prompt sentence that may be used to instruct the generative AI model is as follows: Please generate a robot program that captures camera video in a factory, analyzes it to detect forklifts and workers, and provides real-time voice guidance and AR visualization for worker safety. The robot is equipped with a wireless communication module, signal processing unit, speaker, and display. For example, if a forklift is approaching from the right, the robot should announce, “Caution! A forklift is approaching from your right,” and visually show the forklift's position in AR.

As such, the system offers real-time, adaptive safety and navigation support to users by integrating sensor data, generative artificial intelligence, and presentation modules based on both the environment and the user's dynamic emotional condition.

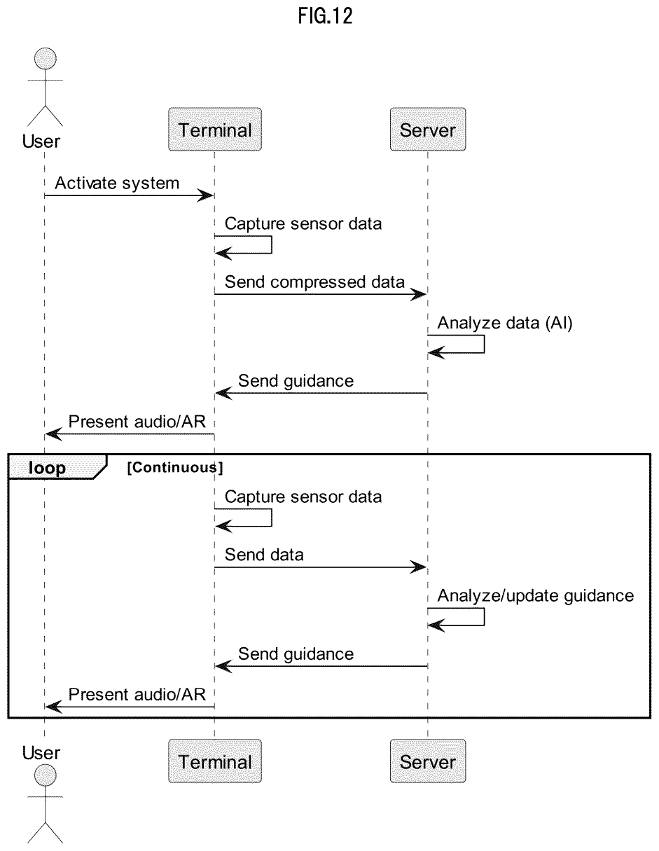

The following describes the processing flow using FIG. 12.

### Step 1:

The user puts on the terminal (such as smart glasses) and activates the system. The terminal initializes the camera, microphone, biometric sensors, wireless communication module, and display. input: user action (system activation). output: terminal components active and ready for data acquisition.

### Step 2:

The terminal captures real-time video data from the built-in camera, collects audio data from the microphone, and gathers biometric data from sensors such as heart rate monitors. The terminal writes each video frame, audio sample, and biometric reading to a local buffer with synchronized timestamps. input: ambient environment, user's physiological status. output: raw video frames, audio data, and biometric measurements with timestamps.

### Step 3:

The terminal compresses the captured video using a signal processing module (for example, FFmpeg with H.264 encoding), and processes the audio and biometric data into a transmission-ready format. The terminal packages these data streams with metadata and transmits the packet via wireless communication (such as Wi-Fi). input: raw video, audio, biometric data. operation: compression, encoding, synchronization, packaging. output: compressed data packets with metadata.

### Step 4:

The server receives the compressed data packet through the network interface. The server decodes the video, audio, and biometric data, reconstructs the synchronized streams, and checks integrity and consistency of the data. input: compressed data packets from terminal. operation: data decoding, integrity verification, stream reconstruction. output: decoded video frames, audio samples, and biometric measurements with timestamps.

### Step 5:

The server uses a generative AI model (such as a deep neural network for multimodal scene recognition) to analyze the video and audio. The server applies object detection algorithms (e.g., YOLOv5) to the video to identify dynamic and static objects in the user's environment, and uses tracking algorithms (e.g., OpenCV-based trackers) to predict movement trajectories. In parallel, the server applies machine learning models to the audio and biometric data to estimate the user's emotional state (e.g., calm, anxious). input: decoded video frames, audio, biometric signals. operation: object recognition, trajectory prediction, emotion estimation. output: structured scene data (object types, locations, movement), estimated emotional state.

### Step 6:

The server generates guidance content based on the scene analysis and emotion estimation. The server uses a text-to-speech module to synthesize an auditory message and creates visual AR data (such as arrows or icons) to point out hazards or navigation cues. The content and tone of guidance are adapted based on the user's emotional state. input: structured scene data, emotional state. operation: message generation, AR overlay creation, personalized adjustment. output: audio guidance data (speech file), visual AR overlay data.

### Step 7:

The server packages the generated guidance data and transmits it to the terminal via the wireless network. input: generated audio and AR data. operation: data packaging, network transmission. output: guidance data packet sent to terminal.

### Step 8:

The terminal receives the guidance data packet, decodes the audio and AR information, and coordinates presentation. The terminal plays the audio message using the built-in speaker and displays the AR overlay through the display. input: guidance data packet. operation: decoding, audio playback, AR rendering. output: auditory and visual guidance to the user.

### Step 9:

The user perceives the auditory and visual guidance, assesses the situation, and takes appropriate action (such as stopping, turning, or continuing safely). input: auditory and visual guidance. operation: user decision-making based on information. output: adjusted user behavior for increased safety and awareness.

### Step 10:

The terminal continues to capture and transmit new data, and the server continuously processes incoming information, so that the guidance is always updated in real time according to changes in the environment and the user's status. input: ongoing sensor data streams. operation: continuous monitoring and adaptive processing. output: updated guidance and support as conditions change.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

It is difficult for visually impaired users to accurately and promptly perceive surrounding environmental information in real time, especially when their emotional state, such as anxiety or stress, may further restrict their safe and confident behavior. Conventional visual support systems do not consider the psychological state of the user and thus fail to provide adaptive and personalized guidance, potentially increasing user anxiety and reducing safety during daily activities.

The specific processing by the specific processing unit 290 of the data processing device 12 in Example 2 is realized by the following means.

The present invention provides a server comprising a processor configured to acquire environment information and user biological information from acquisition units, transmit data via a wireless network, analyze and integrate environment and user emotional status using multimodal artificial intelligence, generate individualized assistance information based on both environmental and emotional data, and provide both auditory and augmented reality visual guidance to the user. This enables visually impaired users to accurately understand their environment and receive real-time, emotion-aware adaptive support personalized to their psychological state, enhancing both their safety and confidence in daily life.

The term “environment information” refers to data relating to the surroundings of the user, including visual, auditory, and spatial information captured by sensors.

The term “environment information acquisition unit” refers to a hardware component, such as a camera or sensor, that collects data from the user's surroundings.

The term “processor” refers to a computing device or central processing unit configured to execute instructions, perform data analysis, and control the flow of information within the system.

The term “wireless communication network” refers to an infrastructure or medium that enables the transmission of data between devices without physical connections, such as Wi-Fi, Bluetooth, or cellular networks.

The term “user biological information” refers to measurable physiological data originating from the user, including but not limited to heart rate, voice characteristics, and other biometric signals.

The term “analysis unit” refers to a hardware or software module, including artificial intelligence models, that processes and interprets received data.

The term “multiple types of input information” refers to various categories of data entering the system, such as environment information, user voice data, and user biological information.

The term “user emotional status” refers to the psychological or physiological state of the user, characterized by indicators such as anxiety, stress, or calmness.

The term “assistance information” refers to support data generated by the processor to guide and assist the user based on analyzed information.

The term “auditory output unit” refers to a hardware device, such as a speaker, that provides voice or sound-based guidance to the user.

The term “visual output unit” refers to a hardware device, such as a display or augmented reality interface, that provides the user with visual guidance.

The term “augmented reality visual information” refers to graphical or symbolic overlays displayed to the user, which convey additional contextual data in conjunction with real-world views.

The term “integrated artificial intelligence model” refers to a computational framework that combines various artificial intelligence algorithms to process and interpret complex multimodal inputs, such as visual and emotional data.

An embodiment of the invention will now be described in detail, based on the previously defined claims.

The system comprises a processor, an environment information acquisition unit (such as a camera and biosensor-equipped wearable device), a wireless communication network module, an auditory output unit (speaker), and a visual output unit (display providing augmented reality output). The processor may reside on a dedicated server or in cloud computing resources, and is configured to receive, analyze, and synthesize data from the various modules.

The terminal, which may be constructed as wearable smart glasses, acquires real-time environment information using an integrated high-resolution camera. The same terminal is equipped with a microphone for collecting the user's voice, and biosensors for collecting biological information such as heart rate. The terminal compresses the acquired environment information using a signal processor and data compression module such as an H.264 codec. The gathered data, including compressed environment video, voice data, and user biological information, is transmitted to the server using the wireless communication network (such as Wi-Fi or LTE).

The server, acting as a processor, receives the data and decompresses the environment information for analysis. The server uses a multimodal analysis unit (for example, a combination of computer vision algorithms, such as YOLO for object detection, and emotion recognition algorithms) to process multiple types of input information: image data, user voice, and biosensor data. The server analyzes the environment to detect obstacles and other important objects, and determines the psychological and physiological state of the user by analyzing audio features and biometric information. The server then integrates these results using an integrated artificial intelligence model to generate individualized “assistance information.” This assistance information consists of auditory guidance (customized spoken messages), as well as augmented reality (AR) visual guidance (graphics, symbols, or highlights rendered in synchronization with the real world).

The server transmits the generated assistance information back to the terminal. The terminal decodes the received guidance data and outputs it: the auditory output unit (speaker) plays the synthesized message for the user, and the visual output unit (display) presents the augmented reality guidance, such as a highlighted object or directional arrow. This dual-modality presentation enables the user to perceive both the presence and location of obstacles and to act according to personalized, real-time recommendation.

For example, if the user is about to cross a street and an approaching bicycle is detected while the user's heart rate indicates anxiety, the system may output the following message via the speaker: “A bicycle is approaching ahead. Remain calm and be careful.” At the same time, an AR overlay appears in the user's visual field, marking the direction and activity of the bicycle. This allows the user to avoid potential hazards and move safely with increased confidence.

Example of a prompt sentence for a generative AI model:

“Imagine a visually impaired user about to cross a busy street. The smart glasses detect a fast-approaching car and increased anxiety in the user's voice. Generate a spoken alert that reassuringly says, ‘A car is approaching quickly on your left. Please stop and wait until it passes.’ Show an AR alert in the user's field of vision indicating the car's direction.”

Through the coordinated operation of the terminal, server, hardware components (camera, microphone, biosensors, speaker, AR display), and software modules (H.264 codec, wireless communication software, object recognition such as YOLO, integrated artificial intelligence model for multimodal analysis), the system delivers real-time, adaptive, and contextually aware support for visually impaired users. The invention ensures they receive guidance and situational awareness that integrates not only environmental data but also their emotional and physiological state.

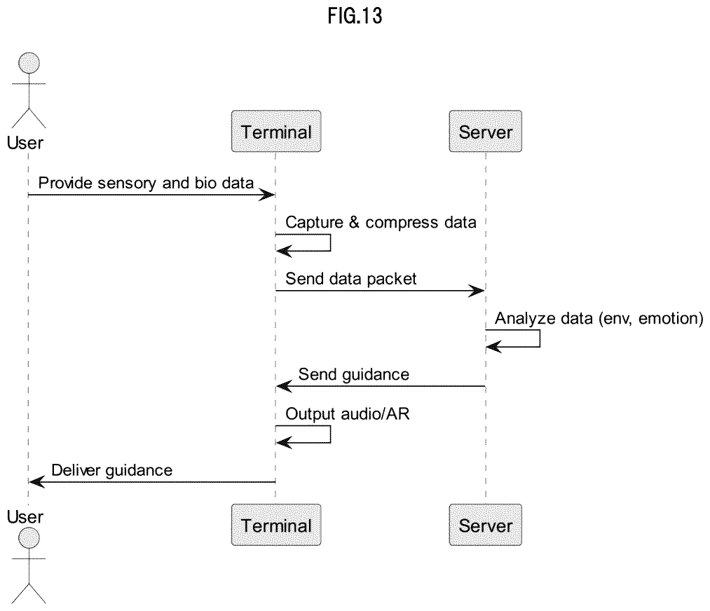

The following describes the processing flow using FIG. 13.

### Step 1:

The terminal acquires real-time environment information by capturing video through a built-in high-resolution camera, and simultaneously collects audio data from a microphone and physiological data, such as heart rate, from biosensors. The input for this step is the raw sensory data from the user's surroundings and body. The terminal compresses the captured video using an H.264 codec and packages the compressed video, audio, and biosensor data into a data packet. The output is a unified data packet ready for transmission.

### Step 2:

The terminal transmits the unified data packet containing compressed video, audio, and physiological data to the server via a wireless communication network, such as Wi-Fi or LTE. The input is the data packet generated in Step 1. The output is the successful delivery of the data packet to the server for further processing.

### Step 3:

The server receives the data packet from the terminal. The input is the transmitted packet containing the compressed video, audio, and physiological data. The server decompresses the video stream and extracts the audio and physiological data. The server processes the image data using an object recognition algorithm, such as YOLO, to identify and locate relevant environmental objects (e.g., bicycles, cars, pedestrians). For the audio and physiological data, the server applies an emotion recognition algorithm to analyze features and determine the user's emotional status, such as anxiety or calmness. The output consists of recognized environmental objects and the user's assessed emotional state.

### Step 4:

The server integrates the results from the environmental and emotional analyses using a multimodal artificial intelligence model. The input is the object detection results and the emotional state assessment from Step 3. The server synthesizes this information and generates personalized assistance information, including an auditory guidance message and augmented reality (AR) visual instruction tailored to the user's context and psychological state. The output is a set of assistance information data, including a speech message and AR visual data.

### Step 5:

The server transmits the generated assistance information, including the speech message and AR visual data, to the terminal via the wireless communication network. The input is the assistance information data generated in Step 4. The output is the successful receipt of personalized guidance data by the terminal.

### Step 6:

The terminal receives the guidance data from the server. The input is the assistance information data, including the speech message and AR visual data. The terminal decodes the speech message and plays it through a built-in speaker, providing real-time auditory guidance to the user. Simultaneously, the terminal renders the AR visual instruction on its display, visually highlighting detected objects or providing directional cues. The output is the real-time delivery of multisensory guidance to the user.

### Step 7:

The user perceives the auditory and AR visual guidance provided by the terminal. The input is the spoken instruction and visual overlay presented in their field of view. Based on this multisensory information, the user interprets the guidance and physically responds, such as pausing, changing direction, or taking other precautionary actions to ensure safe navigation. The output is the user's adaptive behavior based on the real-time, personalized support.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Visually impaired individuals face significant challenges in safely navigating their environment due to insufficient real-time support that takes both environmental hazards and the user's emotional state into account. Conventional assistive systems often fail to provide adaptive guidance tailored to the user's psychological condition, resulting in increased anxiety, stress, and potential safety risks. There exists a need for a guidance system that offers comprehensive and personalized support by analyzing environmental and user state data to improve user safety and assurance during daily activities.

The specific processing by the specific processing unit 290 of the data processing device 12 in Application Example 2 is realized by the following means.

The present invention provides a server comprising a processor configured to acquire environmental information and user state information, transmit such information between detection, analysis, and output units via a wireless communication network, integrate and analyze multiple types of environmental and biometric data using an artificial intelligence model, generate adaptive guidance information and augmented reality display data based on both the detected scenario and the user's emotional state, and output this information through audio and visual means. This enables real-time, adaptive, and multimodal assistance that enhances situational awareness and emotional reassurance for visually impaired users, thereby improving safety in everyday environments.

The term “environmental information” refers to data representing the surroundings of a user, including but not limited to image data, video data, or sensor data captured by detection units.

The term “detection unit” refers to a hardware or software component capable of sensing or obtaining environmental information, such as a camera, sensor, or other input device.

The term “user state information” refers to data indicating the physical, physiological, or emotional state of a user, which may include biometric signals, voice characteristics, or other physiological parameters.

The term “analysis unit” refers to a processing entity, typically including a processor, that receives environmental and user state information and conducts analysis using computational models.

The term “wireless communication network” refers to a network configuration enabling data transmissions between system components without physical connection, such as Wi-Fi, cellular networks, or other electromagnetic communication systems.

The term “artificial intelligence model” refers to a data processing model, including but not limited to machine learning or deep learning algorithms, capable of integrating and analyzing multiple types of input data to derive contextual information.

The term “guidance information” refers to information generated as instructions, alerts, or recommendations that are intended to assist the user based on both environmental analysis and user state analysis.

The term “audio output unit” refers to a device or module configured to convert guidance information into sound signals perceivable by the user, such as a speaker, earpiece, or similar apparatus.

The term “augmented reality display data” refers to information formatted for visual output intended to overlay, highlight, or otherwise enhance a user's perception of their surroundings by means of a visual display.

The term “display output unit” refers to a component or device capable of rendering augmented reality display data visible to the user, such as a head-mounted display, wearable display device, or other visual interface.

The term “processor” refers to a device or set of devices capable of executing instructions to perform data acquisition, transmission, analysis, integration, and output as required by the system.

### Embodiment for Implementing the Invention

A preferred embodiment of the present invention relates to a guidance system that provides real-time, adaptive support to visually impaired users by integrating environmental information, user state information, and processing these data using a processor equipped with artificial intelligence capabilities.

The terminal, which may be realized as a wearable information processing device such as smart glasses, acquires environmental information through a detection unit such as a built-in camera and integrated sensors. The terminal is also configured to acquire user state information through a microphone (for capturing voice data) and biometric sensors (for capturing data such as heart rate or galvanic skin response). Examples of suitable hardware include commercially available smart glasses, wearable displays, microphones, and physiological measurement devices.

The terminal compresses the captured environmental and user state information using on-device software modules, for example, a signal compression codec and sensor data acquisition library. The compressed data is then transmitted to a remote server or cloud computing resource over a wireless communication network such as Wi-Fi, LTE, or other mobile communication systems. The server, implemented as a general-purpose data processing apparatus or cloud infrastructure, receives the environmental information and user state information. The server uses analysis unit software, which may be realized through artificial intelligence models implemented with machine learning frameworks such as TensorFlow, PyTorch, or other suitable deep learning platforms. The server processes the received video and sensor data to detect objects, people, obstacles, and interpret surrounding scene context. Simultaneously, the server runs emotion recognition software, such as emotion AI toolkits or APIs, to interpret the user's emotional or physiological state based on speech and biometric data.

By integrating the results of environmental analysis and user state analysis, the server generates audio guidance information tailored to the user's current situation and emotional state. The server utilizes a generative AI model (for example, a large language model or prompt-based natural language generation module) to compose natural-language guidance messages. Furthermore, the server generates augmented reality display data to visually highlight objects or hazards in the user's field of view.

The server then transmits the generated audio data and augmented reality display data back to the terminal. The terminal decodes and outputs the audio message through an audio output unit such as a bone conduction speaker or earpiece. Simultaneously, the augmented reality data is presented to the user through a display output unit, such as a transparent head-mounted display, by overlaying highlighted graphics or warning symbols corresponding to detected hazards. The user relies on the received audio guidance and AR visual cues to make informed decisions while navigating their environment, thereby enhancing both safety and psychological comfort. As an example, the envisioned hardware and software combinations used for this invention include:
Wearable devices: smart glasses, wearable displays, microphones, biometric sensors
Communication network: wireless network modules, including Wi-Fi or mobile communication chips
Server systems: generic data processing servers or cloud computing instances
Artificial Intelligence: machine learning frameworks such as TensorFlow and PyTorch; emotion recognition APIs such as emotion detection libraries; generative AI models for prompt-based guidance generation

A concrete example is as follows:

When a visually impaired user wearing the terminal walks alone at night, the detection unit of the terminal captures video showing a person approaching rapidly. The microphone captures the user's unsteady voice while biometric sensors register an elevated heart rate. The terminal transmits all data to the server. The server's AI model detects the approaching person and, based on emotion analysis, determines the user is anxious. The server then generates both a natural language audio message and AR data—such as: “Please stay calm. There is a person approaching ahead. I recommend moving to the right to avoid the person.”—which are then presented to the user via audio and AR visual cues.

An example of a prompt sentence for use with a generative AI model is:

“Imagine a user with visual impairment walking alone at night. If your system's video model detects a person suddenly approaching and the emotion model detects user anxiety, generate an audio message: ‘Stay calm. There is a person ahead; please move right.’ Also, output AR metadata to highlight the person on the smart glasses display.”

Through this mechanism, the invention enables visually impaired users to receive real-time, context-sensitive, and emotionally adaptive support, greatly improving navigational safety and confidence.

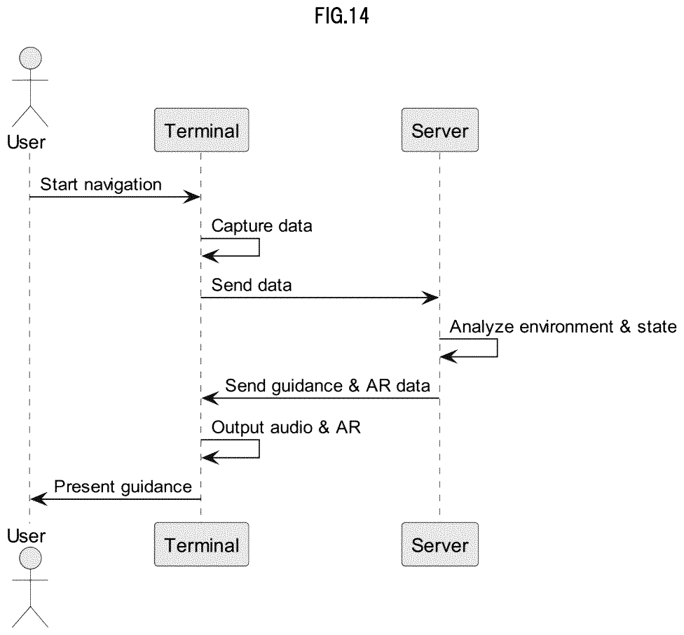

The following describes the processing flow using FIG. 14.

### Step 1:

The terminal initiates the acquisition of environmental and user state information. As input, the terminal receives image data from its camera, audio data from its microphone, and biometric data (such as heart rate or skin conductivity) from integrated sensors. The terminal processes this input by compressing the video stream using a video codec (such as H.264) and aggregating audio and biometric data into suitable packets. The output is a set of compressed video data and bundled sensor data ready for transmission.

### Step 2:

The terminal transmits the prepared data to the server via a wireless communication network. The input to this step is the compressed video and bundled sensor data generated in Step 1. The terminal uses its wireless communication module, such as Wi-Fi or LTE, to send these data packets to the server. The output is the data successfully received by the server for further processing.

### Step 3:

The server receives and preprocesses the incoming data packets. As input, the server takes in compressed video, audio, and biometric data. The server performs decompression on the video stream using appropriate decoding libraries (for example, FFmpeg) and parses the sensor data streams to organize them for analysis. The output is a restored set of video frames and synchronized sensor data arrays.

### Step 4:

The server executes analysis on the environmental data using an artificial intelligence model. The input for this step is the set of decompressed video frames. The server applies a deep learning-based model (such as a convolutional neural network or YOLO for object detection) to process each frame, identifying objects, people, obstacles, and extracting scene context. The output consists of labeled objects and detected hazards for each video frame.

### Step 5:

The server analyzes the user's state based on audio and biometric information. The input here is audio data and biometric sensor readings. The server applies emotion analysis programs (for example, speech emotion recognition and physiological signal analysis using dedicated AI models or APIs), detecting the user's emotional state such as anxiety, calmness, or stress. The output is an emotional or physiological state classification result.

### Step 6:

The server integrates the outputs from environmental analysis and user state analysis. As input, the server uses recognized environmental hazards and the classified user emotional state. The server processes this input by making a context-sensitive decision and generates guidance instructions using a generative AI model based on prompt sentences, such as: “Generate a supportive message if an anxious user is facing an approaching person in the video.” The output is a natural language guidance message and augmented reality (AR) metadata specifying how to visually highlight hazards on the display.

### Step 7:

The server encodes and transmits the response data to the terminal. As input, the guidance message is converted into audio data using speech synthesis, and the AR metadata is formatted for visualization. The server transmits these to the terminal using a network protocol. The output is the audio and AR data delivered to the terminal.

### Step 8:

The terminal receives and decodes the returned data. As input, it obtains the audio data and AR metadata from the server. The terminal decodes the audio file and plays it through its speaker, while simultaneously rendering the AR overlay on the display based on the metadata (for example, displaying a red box around a detected obstacle). The output is the actual sensory feedback provided to the user—auditory guidance and visual AR cues.

### Step 9:

The user interprets and responds to the feedback. The input for this step is the audible guidance message and the visual AR cues seen on the display. The user comprehends these outputs and, as a result, takes action as necessary—for example, moving to avoid an obstacle or changing direction to enhance safety. The output is the user's physical response, which directly improves their navigation and situational awareness.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

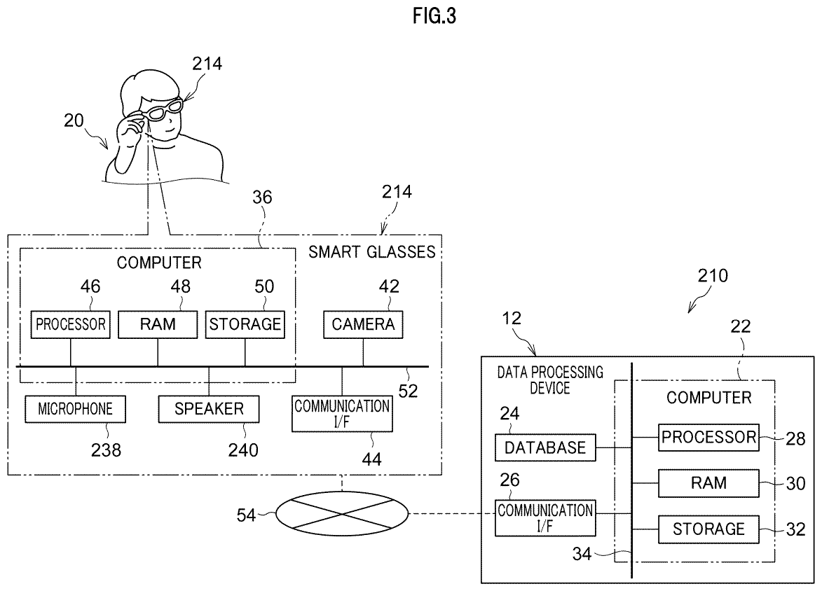

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

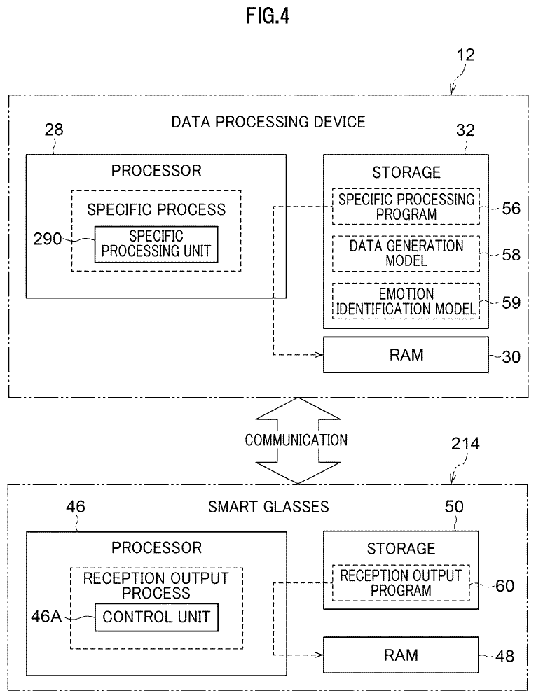

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

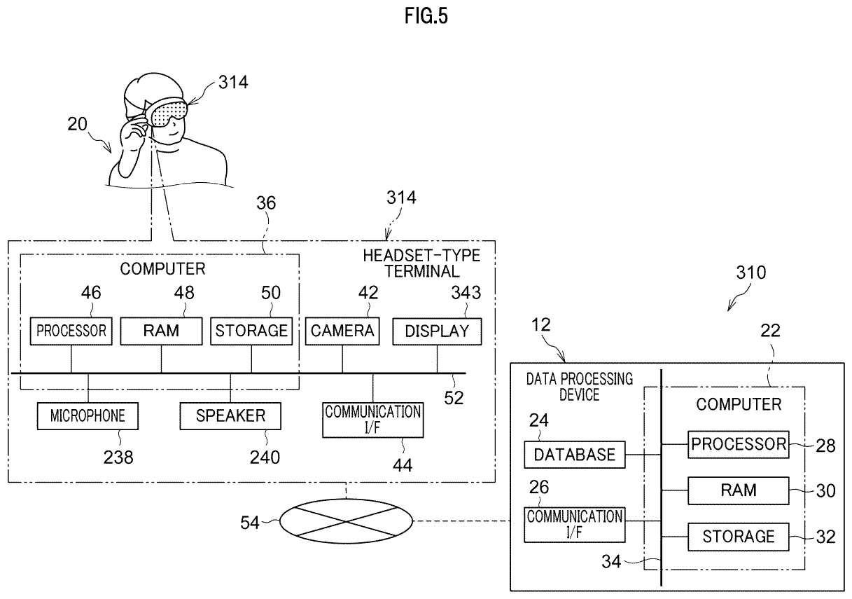

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12. The data processing device 12 includes a computer 22, a database 24, and a

communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

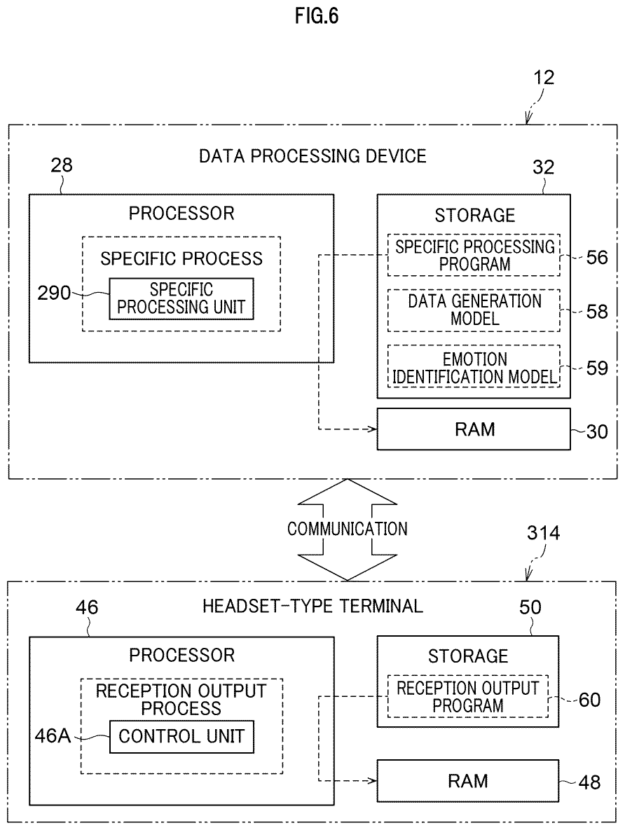

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

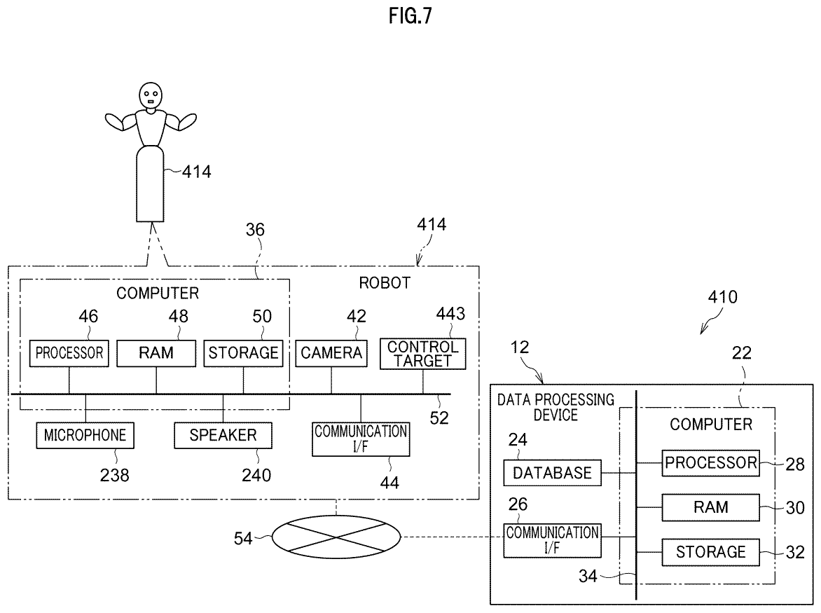

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

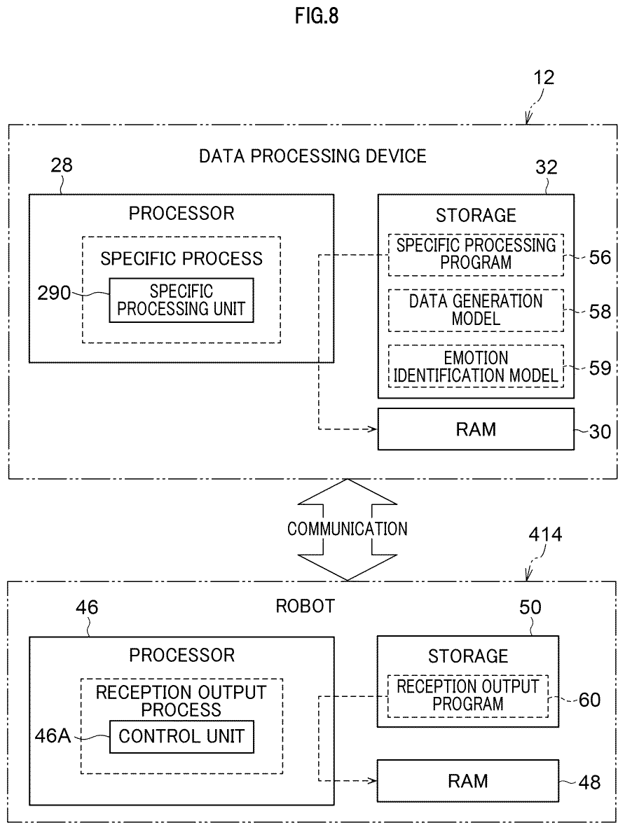

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example I as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

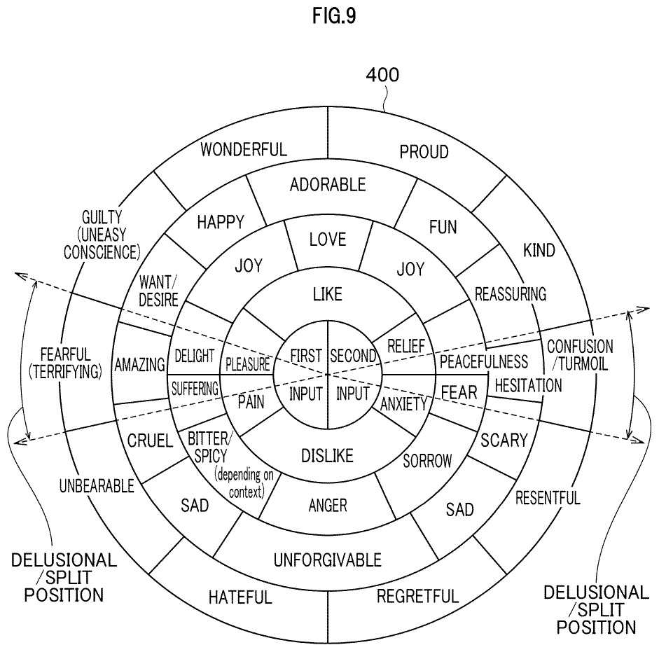

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

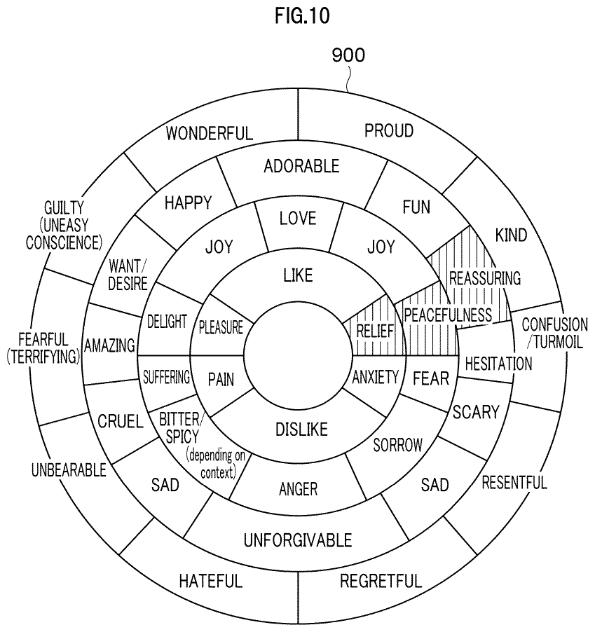

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire image information from a surrounding area of a user using an acquisition unit, perform compression processing on the acquired image information using an information compression method,
transmit and receive the compressed image information via a wireless communication line, restore the received compressed image information, analyze the restored image information using a generative information processing model to perform at least one of object recognition, human recognition, or character recognition,
generate audio guidance information for the user based on the analysis results,
and generate and visually present augmented reality information to the user based on the analysis results.

### (Supplementary 2)

The system according to Supplementary 1,
wherein the processor is configured to
compress the image information acquired by the acquisition unit, and transmit the compressed image information to the analysis unit via the wireless communication line.

### (Supplementary 3)

The system according to Supplementary 1,
wherein the processor is configured to
utilize the generative information processing model to analyze the image information with a plurality of information processing methods, and generate data for both the audio guidance information and the augmented reality information based on the analysis results.

### Application Example 1

### (Supplementary 1)

A system comprising a processor,
wherein the processor is configured to
acquire input information from an input device unit,
convert the acquired input information into a predetermined format and transmit it via a communication device unit,
receive and analyze the transmitted input information at an information processing device unit, generate data based on a recognition of a situation by a data generation unit,
output auditory information generated by the data generation unit through an auditory presentation device unit,
present visual information generated by the data generation unit as augmented reality through a visual presentation device unit,
analyze biometric information and acoustic information acquired from the input device unit to estimate a user's emotional state with an emotion estimation unit,
and control the contents or expressions of the auditory presentation and visual presentation in accordance with the estimated emotional state by a control unit.

### (Supplementary 2)

The system according to supplementary 1,
wherein the processor is configured to transmit the input information and biometric information acquired by the input device unit to the information processing device unit via wireless communication.

### (Supplementary 3)

The system according to supplementary 1,
wherein the processor is configured to analyze the input information and biometric information by using a generative artificial intelligence model to perform situation recognition and emotion estimation.

### Example 2

### (Supplementary 1)

A system comprising a processor,
wherein the processor is configured to
acquire environment information from an environment information acquisition unit, transmit acquired environment information and user biological information to the processor via a wireless communication network,
integrate and analyze multiple types of input information including environment information and user emotional status using an analysis unit,
generate assistance information adapted based on analysis results of the environment and the psychological state of a user,
provide auditory guidance to the user based on the generated assistance information through an auditory output unit,
provide augmented reality visual information to the user based on the generated assistance information through a visual output unit, and
detect and analyze voice data and biological information of the user to determine an emotional state of the user.

### (Supplementary 2)

The system according to supplementary 1,
wherein the processor is configured to transmit the acquired environment information and the user biological information to the processor via the wireless network.

### (Supplementary 3)

The system according to supplementary 1,
wherein the processor is configured to perform multimodal analysis including object recognition processing and emotion analysis processing using an integrated artificial intelligence model.

### Application Example 2

### (Supplementary 1)

A system comprising a processor,
wherein the processor is configured to
acquire environmental information from a detection unit,
transmit the acquired environmental information and user state information to an analysis unit via a wireless communication network,
analyze the received environmental information by integrating multiple types of data using an artificial intelligence model to generate analysis results,
acquire user state information based on the analysis results,
integrate the analysis results and user state information to generate guidance information as audio information,
output the generated guidance information as audio through an audio output unit,
generate augmented reality display data based on the analysis results and user state information, and
display the augmented reality display data through a display output unit.

### (Supplementary 2)

The system according to supplementary 1,
wherein the processor is configured to transmit the acquired environmental information and user state information to the analysis unit through a wireless communication network.

### (Supplementary 3)

The system according to supplementary 1,
wherein the processor is configured to analyze the environmental information by employing an artificial intelligence model that integrates and analyzes multiple types of information and outputs analysis results.

What is claimed is:

1. A system comprising a processor,
wherein the processor is configured to capture front-facing video data,
analyze the captured video data using an analysis server,
output information based on the analyzed video data as audio guidance to a visually impaired user, and
display information based on the analyzed video data as augmented reality on a display.

2. The system of claim 1, wherein the processor is configured to transmit the captured video data to the analysis server via a wireless network.

3. The system of claim 1, wherein the processor is configured to use a multimodal artificial intelligence for analyzing the video data in the analysis server.

4. The system of claim 1, wherein the processor is configured to generate data for audio guidance and augmented reality display based on the analyzed video data in the analysis server.

5. The system of claim 1, wherein the processor is configured to decode the audio guidance data transmitted from the analysis server and to output audio guidance.

6. The system of claim 1, wherein the processor is configured to decode the augmented reality display data transmitted from the analysis server and to display the decoded data on the display.
